(19) United States
(12) Patent Application Publication
(10) Pub. No.: US 2021/0255361 A1
(43) Pub. Date: Aug. 19, 2021

(54) SYSTEMS AND METHODS FOR OPTIMUM SUBSURFACE SENSOR USAGE

(71) Applicant: HALLIBURTON ENERGY SERVICES, INC., Houston, TX (US)

(72) Inventors: Joshua Lane CAMP, Friendswood, TX (US); Ajish Sreeni Radhakrishnan POTTY, Missouri City, TX (US); Neha SAHDEV, Tomball, TX (US)

(73) Assignee: HALLIBURTON ENERGY SERVICES, INC., Houston, TX (US)

(21) Appl. No.: 16/791,982

(22) Filed: Feb. 14, 2020

(51) Int. Cl. G01V 99/00; E21B 47/04; E21B 47/022; E21B 49/00; E21B 47/06; G06F 30/27

(52) U.S. Cl. CPC G01V 99/005; E21B 47/04; E21B 47/022; E21B 43/267; E21B 47/06; G06F 30/27; E21B 2200/20; E21B 49/00

(57) ABSTRACT

Disclosed are systems and methods for receiving surface data and downhole sensor data associated with at least one first hydraulic fracturing well, generating a prediction model for the at least one first hydraulic fracturing well that determines a prediction for a subsurface value for the at least one first hydraulic fracturing well, generating an error model for the at least one first hydraulic fracturing well that determines an estimated prediction error between the prediction for the subsurface value for the at least one first hydraulic fracturing well and an actual subsurface value for the at least one first hydraulic fracturing well, determining a status of at least one feature associated with the estimated prediction error between a prediction for a subsurface value for at least one second hydraulic fracturing well and an actual subsurface value for the at least one second hydraulic fracturing well, and collecting additional downhole sensor data.

### TECHNICAL FIELD

The present technology pertains to subsurface sensor optimization and more specifically using an error model to determine when to obtain subsurface sensor measurements to improve predictions for a fracture job.

### BACKGROUND

A typical fracturing job may be predicted based on surface measurements and downhole sensor measurements. It is desirable to eliminate downhole sensor measurements because they are expensive both financially and computationally. However, in certain instances, it is important to perform downhole sensor measurements. The benefits may outweigh the costs when predictions are not accurate. It is desirable to determine when to obtain downhole sensor measurements and what type of downhole sensor measurements.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. The embodiments herein may be better understood by referring to the following description in conjunction with the accompanying drawings in which like reference numerals indicate analogous, identical, or functionally similar elements. Understanding that these drawings depict only exemplary embodiments of the disclosure and are not therefore to be considered to be limiting of its scope, the principles herein are described and explained with additional specificity and detail through the use of the accompanying drawings in which:

FIG. 1A is a schematic diagram of a fracturing system that may include a hydraulic fracturing subsurface optimization system, in accordance with some examples;

FIG. 1B is a diagram illustrating an example of a subterranean formation in which a fracturing operation may be performed, in accordance with some examples;

FIG. 2 is a block diagram of the hydraulic fracturing subsurface sensor optimization system that may be implemented to reduce subsurface sensor measurements, in accordance with some examples;

FIG. 3 is a flow diagram for the hydraulic fracturing subsurface sensor optimization system showing a prediction model, in accordance with some examples;

FIG. 4 is another flow diagram for the hydraulic fracturing subsurface sensor optimization system showing an error model, in accordance with some examples;

FIG. 5 is another flow diagram for the hydraulic fracturing subsurface sensor optimization system showing estimated prediction error, in accordance with some examples;

FIG. 6 is a diagram of data and augmented data associated with the hydraulic fracturing subsurface sensor optimization system, in accordance with some examples;

FIG. 7 is a flow diagram of the hydraulic fracturing subsurface optimization system showing collection of data for features having highest prediction errors, in accordance with some examples;

FIG. 8 is a flowchart of an example method for hydraulic fracturing subsurface sensor optimization, in accordance with some examples;

FIG. 9 is a schematic diagram of an example computing device architecture, in accordance with some examples.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

It should be understood at the outset that although illustrative implementations of one or more embodiments are illustrated below, the disclosed apparatus and methods may be implemented using any number of techniques. The disclosure should in no way be limited to the illustrative implementations, drawings, and techniques illustrated herein, but may be modified within the scope of the appended claims along with their full scope of equivalents. The various characteristics described in more detail below, will be readily apparent to those skilled in the art with the aid of this disclosure upon reading the following detailed description, and by referring to the accompanying drawings.

Disclosed herein are systems, methods, and computer-readable storage media for subsurface sensor optimization based on an error model that may be used to determine when a prediction model deteriorates in accuracy and indicate that subsurface sensor measurements are to be obtained. The subsurface measurements may be associated with or based on certain features of hydraulic fracturing wells and may be used to improve the accuracy of the prediction model.

A hydraulic fracturing subsurface optimization system may receive surface data associated with at least one first hydraulic fracturing well and receive downhole sensor data associated with the at least one first hydraulic fracturing well. Using the downhole sensor data and the surface data, the hydraulic fracturing subsurface optimization system may generate a prediction model that can be used to predict one or more subsurface metrics for at least one second hydraulic fracturing well. As an example, the at least one second hydraulic fracturing well may be associated with a different location or region from the at least one first hydraulic fracturing well. As another example, the at least one second hydraulic fracturing well may be a different hydraulic fracturing well and from a group or cluster of hydraulic fracturing wells not associated with the at least one first hydraulic fracturing well. It be may be difficult to obtain downhole sensor data for the at least one second hydraulic fracturing well or downhole sensor data may not yet be obtained for the at least one second hydraulic fracturing well. Thus, the prediction may not provide entirely accurate predictions for the one or more subsurface metrics for the at least one second hydraulic fracturing well and it may be important to determine how to make the predictions more accurate. New and additional data may be collected, but it may be important to minimize what data is collected and focus on what data to collect. The inability to understand what data to collect may result in financial and computational inefficiencies, among other inefficiencies.

The hydraulic fracturing subsurface optimization system may generate an error model that can be used to determine an estimated prediction error between the predicted one or more subsurface metrics for the at least one first hydraulic fracturing well and actual subsurface metrics. The prediction error may be particularly pronounced for certain reasons and caused by the lack of data associated with certain factors or features. The hydraulic fracturing subsurface optimization system can determine a status of at least one feature associated with the prediction error. As an example, the status may be one of low, good, minor, or minimal (green), medium or mediocre (yellow), or high or poor (red). The status may indicate that the feature may have caused the prediction error because of a number of reasons such as a lack of data associated with the feature, outdated data associated with the feature, and inapplicable data associated with the feature, among others. Alternatively, the data may be associated with a different location that renders it inaccurate. Based on the status for each of the features, the hydraulic fracturing subsurface optimization system can obtain additional or new subsurface sensor data at the least one second hydraulic fracturing well to improve the at least one feature associated with the prediction error. For instance, the hydraulic fracturing subsurface optimization system may obtain new data to improve the prediction model. Once the error and the status of the features are known, the model can be improved for those features.

According to at least one aspect, an example method for subsurface sensor optimization is provided. The method can include receiving, by at least one processor, surface data associated with at least one first hydraulic fracturing well, receiving, by the at least one processor, downhole sensor data associated with the at least one first hydraulic fracturing well, generating, by the at least one processor, a prediction model for the at least one first hydraulic fracturing well that determines a prediction for a subsurface value for the at least one first hydraulic fracturing well, generating, by the at least one processor, an error model for the at least one first hydraulic fracturing well that determines an estimated prediction error between the prediction for the subsurface value for the at least one first hydraulic fracturing well and an actual subsurface value for the at least one first hydraulic fracturing well, determining, by the at least one processor, a status of at least one feature associated with the estimated prediction error between a prediction for a subsurface value for at least one second hydraulic fracturing well and an actual subsurface value for the at least one second hydraulic fracturing well, and collecting, by the at least one processor, additional downhole sensor data at the at least one second hydraulic fracturing well to improve the at least one feature associated with the estimated prediction error between the prediction for the subsurface value for the at least one second hydraulic fracturing well and the actual subsurface value.

According to at least one aspect, an example system for subsurface sensor optimization is provided. The system can include at least one processor coupled with at least one computer-readable storage medium having stored therein instructions which, when executed by the at least one processor, causes the system to receive surface data associated with at least one first hydraulic fracturing well, receive downhole sensor data associated with the at least one first hydraulic fracturing well, generate a prediction model for the at least one first hydraulic fracturing well that determines a prediction for a subsurface value for the at least one first hydraulic fracturing well, generate an error model for the at least one first hydraulic fracturing well that determines an estimated prediction error between the prediction for the subsurface value for the at least one first hydraulic fracturing well and an actual subsurface value for the at least one first hydraulic fracturing well, determine a status of at least one feature associated with the estimated prediction error between a prediction for a subsurface value for at least one second hydraulic fracturing well and an actual subsurface value for the at least one second hydraulic fracturing well, and collect additional downhole sensor data at the at least one second hydraulic fracturing well to improve the at least one feature associated with the estimated prediction error between the prediction for the subsurface value for the at least one second hydraulic fracturing well and the actual subsurface value.

According to at least one aspect, an example non-transitory computer-readable storage medium for subsurface sensor optimization is provided. The non-transitory computer-readable storage medium can include instructions which, when executed by one or more processors, cause the one or more processors to perform operations including receiving surface data associated with at least one first hydraulic fracturing well, receiving downhole sensor data associated with the at least one first hydraulic fracturing well, generating a prediction model for the at least one first hydraulic fracturing well that determines a prediction for a subsurface value for the at least one first hydraulic fracturing well, generating an error model for the at least one first hydraulic fracturing well that determines an estimated prediction error between the prediction for the subsurface value for the at least one first hydraulic fracturing well and an actual subsurface value for the at least one first hydraulic fracturing well, determining a status of at least one feature associated with the estimated prediction error between a prediction for a subsurface value for at least one second hydraulic fracturing well and an actual subsurface value for the at least one second hydraulic fracturing well, and collecting additional downhole sensor data at the at least one second hydraulic fracturing well to improve the at least one feature associated with the estimated prediction error between the prediction for the subsurface value for the at least one second hydraulic fracturing well and the actual subsurface value.

Hydraulic fracturing has been widely applied to stimulate unconventional reservoirs. Hydraulic fracturing jobs have been conducted using a pre-designed job execution plan based on well characteristics, historical design considerations, fracture modeling, location information, and other information. The jobs may have subsurface metrics that can be predicted based on a prediction model.

Productivity associated with a hydraulic fracturing well may be based on a number of factors and features including stress orientation, heterogeneity, natural fractures, and completion design, among others. These may affect how fractures may propagate. The data associated with these factors and features may be obtained by the system discussed herein. Some of the data may be obtained on a surface more easily and readily and some of the data may be obtained more sporadically using subsurface sensors.

Certain types of data may be available at each job such as certain surface data including treatment pressure. However, other types of data may be more rarely collected including subsurface data. The subsurface data may be obtained less often because it is expensive to do so both financially and computationally. The sensors may be expensive to install and the associated data may be expensive to analyze.

The use of advanced and/or downhole sensor diagnostics during hydraulic fracturing operations allows for direct measurement and understanding of subsurface outcomes for fracturing operations. The downhole sensor data can be used for many purposes, including but not limited to, improvements to job completion designs. The job completion designs may be associated with planned job designs and realtime changes and modifications to the planned job designs. However, use of the downhole sensors at scale can be difficult due to increased completion costs, modifications to drilling and completion schedules, and/or modifications to job designs. Recently, machine learning models have been utilized to allow for more cost effective solutions and use of available surface measurements. The surface measurements may be correlated to measurements made by advanced and downhole sensors. As a result, the downhole conditions may be predicted based on the surface measurements with minimal error. As an example, surface pressure-based machine learning (ML) models may be used to predict downhole cluster flow efficiency. Prediction of downhole cluster flow efficiency has conventionally been accomplished using Distributed Acoustic Sensing (DAS) based measurements.

However, the machine learning models are based on a limited number of data points from a small subset of combinations of geomechanical and operational parameters. As a result, the machine learning models may have a limited shelf life and may have to be adjusted. The predictive capabilities of the machine learning models may be adequate within a parameter space of an original dataset. However, if there are changes to the original data set, the performance of the machine learning models may deteriorate. As an example, a machine learning model developed using sensor data from specific job completion designs in one region may not be applicable to a different region due to a number of differences in geography. As another example, as a job completion design changes and a treatment rate is modified to be different from an initial feature design, the machine learning model may not be applicable and/or accurate. Thus, while machine learning models may be good at interpolation, they may not extrapolate to a feature space where data availability is limited. The limited data may provide issues for the machine learning model because the machine learning model may not be used to capture the underlying physics associated with the job.

These issues may be addressed by adding more advanced sensor-based data points to a dataset that may incorporate new features and changes in features. However, it may be difficult to determine when to obtain new data and how to obtain the new data associated with the new features. In one example, it may be a good time to obtain additional data for a machine learning model designed for one location when the machine learning model is used in a different location. However, in other cases, it may be difficult to determine when an original machine learning model is underperforming and not as accurate as desired.

The methods and systems discussed herein may use the base machine learning model discussed above coupled with an additional machine learning model. The additional machine learning model may be used to determine and build an auxiliary correlation between a base machine learning model prediction and certain key characteristics associated with the base machine learning model in addition to further measurements as determined by advanced sensors. The advanced sensors may include Distributed Acoustic Sensing, Distributed Temperature Sensing, Distributed Strain Sensing, microseismic arrays, tilt arrays, logs, and high frequency pressure sensors, among others. The additional machine learning model may be used to determine when the accuracy of the base machine learning model has deteriorated by determining which characteristics of the base machine learning model have inaccuracies. These characteristics may not have a same predictive power as originally designed. This information may be used to plan additional tests with advanced sensors to supplement and improve the original data set.

In one example, the base machine learning model building process may be supplemented with additional steps associated with building an auxiliary error prediction model. The auxiliary error prediction model may be used to make a prediction on one or more errors associated with the base machine learning model and determine a source or “culprit” associated with the one or more errors. The source or “culprit” may be used to determine how the errors can be reduced based on additional data. Because the auxiliary machine learning model may be used to identify one or more causes of the error, the auxiliary machine learning model may be used to determine one or more types of additional data to obtain to assist in eliminating the error.

Full development and implementation of the auxiliary machine learning model may be used to provide advantages associated with efficiencies. The advanced sensors and downhole sensors may be financially expensive and may result in additional computation and data. The additional computation and storage of the data may be avoided based on the systems and methods discussed herein. Surface measurement-based machine learning models may be built based on minimizing sensor measurements. As a result, the machine learning models discussed herein may be used at scale to reduce computation and data storage. Conventional solutions are unable to utilize additional advanced/downhole sensor tests and data because of their computation costs, which lead to accuracy issues. In addition, additional tests may be implemented in an adhoc or random manner because of the inability to determine why and when to perform the additional tests. This results in major inefficiencies and waste of computation and data storage. The machine learning models discussed herein provide efficiencies by maintaining accuracy of surface measurement-based models by providing limited updates to the data by determining why and when to obtain additional subsurface data from sensors. This provides computation improvements and savings in data storage.

The identification of the one or more causes of the error may be associated with one or more features or feature spaces. As an example, the features may be related to location information associated with a hydraulic fracturing well. The location information may include a latitude/longitude, true vertical depth (TVD), measured depth, and well trajectory, among others. The features may be related to reservoir information. The reservoir information may include reservoir properties such as porosity, permeability, and total organic carbon content, among others. The features may be related to completion parameters. The completion parameters may include lateral length, stage spacing, well spacing, cluster spacing, a number of clusters, a number of perforations, and a number of stages, among others. The features may be related to stimulation parameters. The stimulation parameters may include total proppant amount, total fluid amount, and chemical amounts, among others. The features may be related to time-series information. The time-series information may be related to slurry rate, proppant concentration, treating pressure, and chemical concentrations (e.g., friction reducer, surfactant, clay control agent, biocide), among others. The features also may be related to machine generated features such as principal components from principal component analysis (PCA), autoencoded features from an autoencoder neural network, instantaneous shut-in pressure (ISIP), and fracture gradient, among others. Additional features also may be related to one or more combinations of the above example features. As an example, a feature may include a combination of a high slurry rate and a low number of perforations.

The solutions discussed herein may use a data-driven mathematical and statistical prediction model and error model based on surface data and subsurface data to predict and optimize fracturing jobs by performing operations that optimize key performance indicators including, but not limited to maximizing well production, stimulated reservoir volume, NPV, minimizing job time, or minimizing cost. The mathematical and statistical prediction model and error model may each be a machine learning model. The two models can also be a statistical model, a physics based approach, or a combination of these approaches, among other possibilities.

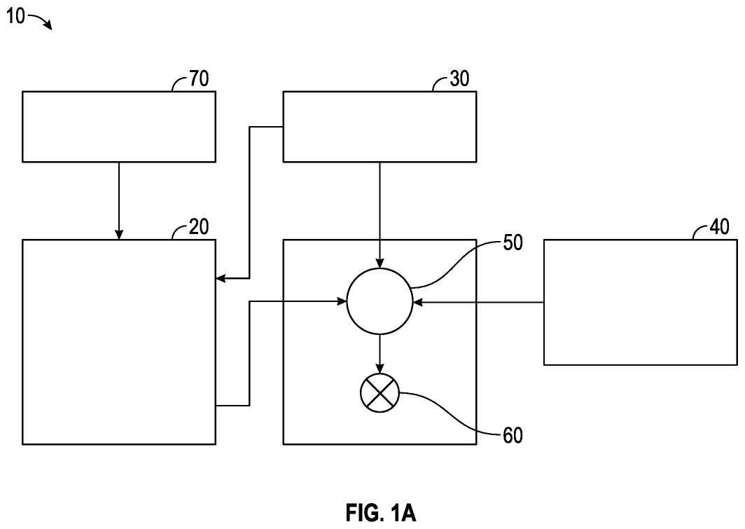

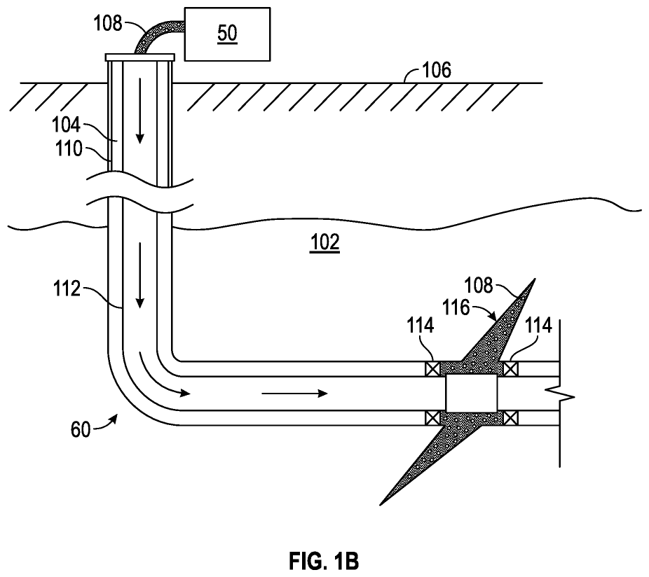

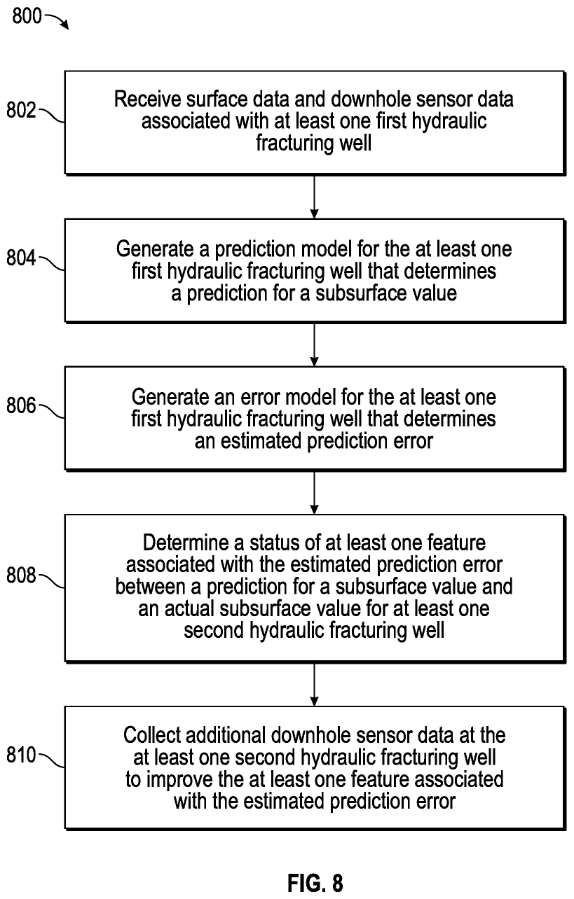

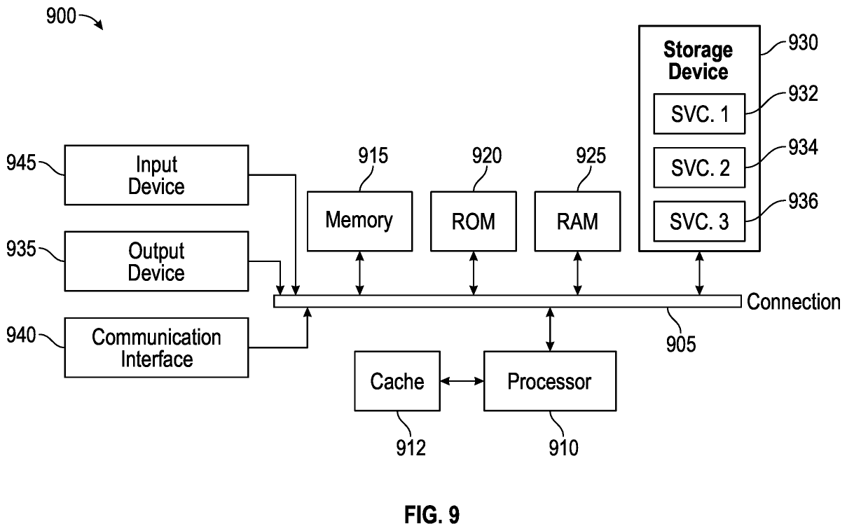

As follows, the disclosure will provide a more detailed description of the systems, methods, computer-readable media and techniques herein for subsurface sensor optimization. The disclosure will begin with a description of example systems and environments, as shown in FIGS. 1A through 7. A description of example methods and technologies for subsurface sensor optimization, as shown in FIG. 8, will then follow. The disclosure concludes with a description of an example computing system architecture, as shown in FIG. 9, which can be implemented for performing computing operations and functions disclosed herein. These variations shall be described herein as the various embodiments are set forth.

The exemplary methods and compositions disclosed herein may directly or indirectly affect one or more components or pieces of equipment associated with the preparation, delivery, recapture, recycling, reuse, and/or disposal of the disclosed compositions. For example, and with reference to FIG. 1A, the disclosed methods and compositions may directly or indirectly affect one or more components or pieces of equipment associated with an exemplary wellbore operating environment 10, or exemplary fracturing system, according to one or more embodiments. In certain instances, the wellbore operating environment 10 includes a fracturing fluid producing apparatus 20, a fluid source 30, a proppant source 40, and a pump and blender system 50 and resides at the surface at a well site where a well 60 is located. In certain instances, the fracturing fluid producing apparatus 20 combines a gel pre-cursor with fluid (e.g., liquid or substantially liquid) from fluid source 30, to produce a hydrated fracturing fluid that is used to fracture the formation. The hydrated fracturing fluid can be a fluid for ready use in a fracture stimulation treatment of the well 60 or a concentrate to which additional fluid is added prior to use in a fracture stimulation of the well 60. In other instances, the fracturing fluid producing apparatus 20 can be omitted and the fracturing fluid sourced directly from the fluid source 30. In certain instances, the fracturing fluid may comprise water, a hydrocarbon fluid, a polymer gel, foam, air, wet gases, and/or other fluids.

The proppant source 40 can include a proppant for combination with the fracturing fluid. The system may also include additive source 70 that provides one or more additives (e.g., gelling agents, weighting agents, diverting agents, and/or other optional additives) to alter the properties of the fracturing fluid. For example, the other additives 70 can be included to reduce pumping friction, to reduce or eliminate the fluid's reaction to the geological formation in which the well is formed, to operate as surfactants, and/or to serve other functions.

The pump and blender system 50 receives the fracturing fluid and combines it with other components, including proppant from the proppant source 40 and/or additional fluid from the additives 70. The resulting mixture may be pumped down the well 60 under a pressure sufficient to create or enhance one or more fractures in a subterranean zone, for example, to stimulate production of fluids from the zone. Notably, in certain instances, the fracturing fluid producing apparatus 20, fluid source 30, and/or proppant source 40 may be equipped with one or more metering devices (not shown) to control the flow of fluids, proppants, and/or other compositions to the pumping and blender system 50. Such metering devices may permit the pumping and blender system 50 to source from one, some or all of the different sources at a given time, and may facilitate the preparation of fracturing fluids in accordance with the present disclosure using continuous mixing or “on-the-fly” methods. Thus, for example, the pump and blender system 50 can provide just fracturing fluid into the well at some times, just proppants at other times, and combinations of those components at yet other times.

FIG. 1B shows the well 60 during a fracturing operation in a portion of a subterranean formation of interest 102 surrounding a well bore 104. The well bore 104 extends from the surface 106, and the fracturing fluid 108 is applied to a portion of the subterranean formation 102 surrounding the horizontal portion of the well bore. Although shown as vertical deviating to horizontal, the well bore 104 may include horizontal, vertical, slant, curved, and other types of well bore geometries and orientations, and the fracturing treatment may be applied to a subterranean zone surrounding any portion of the well bore. The well bore 104 can include a casing 110 that is cemented or otherwise secured to the well bore wall. The well bore 104 can be uncased or include uncased sections. Perforations can be formed in the casing 110 to allow fracturing fluids and/or other materials to flow into the subterranean formation 102. In cased wells, perforations can be formed using shape charges, a perforating gun, hydro-jetting, and/or other tools.

The well is shown with a work string 112 extending from the surface 106 into the well bore 104. The pump and blender system 50 is coupled to a work string 112 to pump the fracturing fluid 108 into the well bore 104. The work string 112 may include coiled tubing, jointed pipe, the well casing 110, and/or other structures that allow fluid to flow into the well bore 104. The work string 112 can include flow control devices, bypass valves, ports, and or other tools or well devices that control a flow of fluid from the interior of the work string 112 into the subterranean zone 102. For example, the work string 112 may include ports adjacent the well bore wall to communicate the fracturing fluid 108 directly into the subterranean formation 102, and/or the work string 112 may include ports that are spaced apart from the well bore wall to communicate the fracturing fluid 108 into an annulus in the well bore between the working string 112 and the well bore wall.

The work string 112 and/or the well bore 104 may include one or more sets of packers 114 that seal the annulus between the work string 112 and well bore 104 to define an interval of the well bore 104 into which the fracturing fluid 108 will be pumped. FIG. 1B shows two packers 114, one defining an uphole boundary of the interval and one defining the downhole end of the interval. When the fracturing fluid 108 is introduced into well bore 104 (e.g., in FIG. 1B, the area of the well bore 104 between packers 114) at a sufficient hydraulic pressure, one or more fractures 116 may be created in the subterranean zone 102. The proppant particulates in the fracturing fluid 108 may enter the fractures 116 where they may remain after the fracturing fluid flows out of the well bore. These proppant particulates may “prop” fractures 116 such that fluids may flow more freely through the fractures 116.

While not specifically illustrated herein, the disclosed methods and compositions may also directly or indirectly affect any transport or delivery equipment used to convey the compositions to the wellbore operating environment 10 such as, for example, any transport vessels, conduits, pipelines, trucks, tubulars, and/or pipes used to fluidically move the compositions from one location to another, any pumps, compressors, or motors used to drive the compositions into motion, any valves or related joints used to regulate the pressure or flow rate of the compositions, and any sensors (i.e., pressure, temperature, volumetric rate, mass, and density), gauges, and/or combinations thereof, and the like.

Disclosed herein are systems and methods for subsurface sensor optimization. A hydraulic fracturing subsurface optimization system may obtain and/or receive input data including surface data and subsurface data associated with at least one hydraulic fracturing well. The hydraulic fracturing subsurface optimization system may use an error model to determine when a prediction model deteriorates in accuracy and indicate that subsurface sensor measurements are to be obtained for certain features to improve the accuracy of the prediction model.

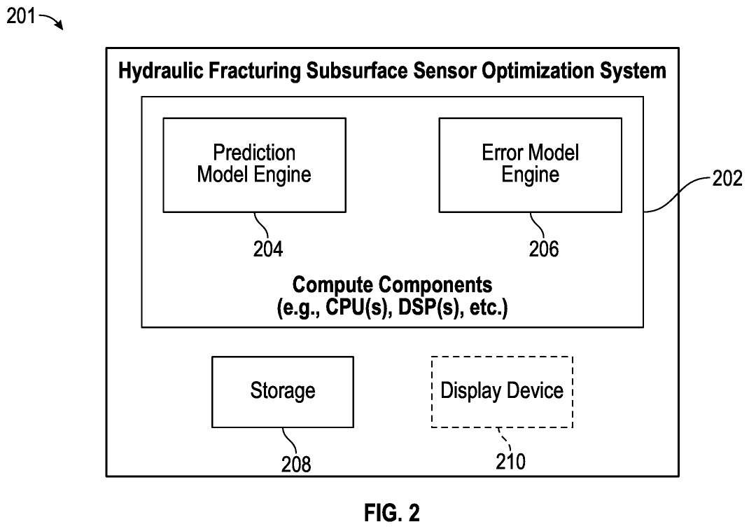

FIG. 2 illustrates a hydraulic fracturing subsurface optimization system 201 according to an example. The hydraulic fracturing subsurface optimization system 201 can be implemented for subsurface sensor optimization as described herein. In this example, the hydraulic fracturing subsurface optimization system 201 can include compute components 202, a prediction model engine 204, an error model engine 206, and a storage 208. In some implementations, the hydraulic fracturing subsurface optimization system 201 can also include a display device 210 for displaying data and graphical elements such as images, videos, text, simulations, and any other media or data content.

The hydraulic fracturing subsurface optimization system 201 may be physically located at the wellbore operating environment 10. Components of the hydraulic fracturing subsurface optimization system 201 may be located downhole and/or on the surface. In addition, the hydraulic fracturing subsurface optimization system 201 may be executed by a computing device such as compute components 202 located downhole and/or on the surface. In one example, the hydraulic fracturing subsurface optimization system 201 may be executed by one or more server computing devices such as a cloud computing device in communication with the hydraulic fracturing subsurface optimization system 201.

The hydraulic fracturing subsurface optimization system 201 can be part of, or implemented by, one or more computing devices, such as one or more servers, one or more personal computers, one or more processors, one or more mobile devices (for example, a smartphone, a camera, a laptop computer, a tablet computer, a smart device, etc.), and/or any other suitable electronic devices. In some cases, the one or more computing devices that include or implement the hydraulic fracturing subsurface optimization system 201 can include one or more hardware components such as, for example, one or more wireless transceivers, one or more input devices, one or more output devices (for example, display device 210), the one or more sensors (for example, an image sensor, a temperature sensor, a pressure sensor, an altitude sensor, a proximity sensor, an inertial measurement unit, etc.), one or more storage devices (for example, storage system 208), one or more processing devices (for example, compute components 202), etc.

As previously mentioned, the hydraulic fracturing subsurface optimization system 201 can include compute components 202. The compute components can be used to implement the prediction model engine 204, the error model engine 206, and/or any other computing component. The compute components 202 can also be used to control, communicate with, and/or interact with the storage 208 and/or the display device 210. The compute components 202 can include electronic circuits and/or other electronic hardware, such as, for example and without limitation, one or more programmable electronic circuits. For example, the compute components 202 can include one or more microprocessors, one or more graphics processing units (GPUs), one or more digital signal processors (DSPs), one or more central processing units (CPUs), one or more image signal processors (ISPs), and/or any other suitable electronic circuits and/or hardware. Moreover, the compute components 202 can include and/or can be implemented using computer software, firmware, or any combination thereof, to perform the various operations described herein.

The prediction model engine 204 can be used to obtain data, process data, analyze data, and store data in one or more databases. The databases may be stored in the storage 208 or in another location.

The prediction model engine 204 may be used to generate one or more prediction models or base models that can be used to predict or determine subsurface metrics for one or more hydraulic fracturing wells. As an example, the prediction model engine 204 may receive surface data associated with one or more hydraulic fracturing wells. The surface data may be associated with one or more data features or factors. As an example, the data features may indicate attributes associated with the hydraulic fracturing wells. The prediction models may be machine learning models or physics based models or models that are based on machine learning and physics.

As an example, the features may be related to location information associated with a hydraulic fracturing well. The location information may include a latitude/longitude, true vertical depth (TVD), measured depth, and well trajectory, among others. The features may also be related to reservoir information. The reservoir information may include reservoir properties such as porosity, permeability, and total organic carbon content, among others. The features may also be related to completion parameters. The completion parameters may include lateral length, stage spacing, well spacing, cluster spacing, a number of clusters, a number of perforations, and a number of stages, among others. The features may also be related to stimulation parameters. The stimulation parameters may include total proppant amount, total fluid amount, and chemical amounts, among others. The features may also be related to time-series information. The time-series information may be related to slurry rate, proppant concentration, treating pressure, and chemical concentrations (e.g., friction reducer, surfactant, clay control agent, biocide), among others. The features also may be related to instantaneous shut-in pressure (ISIP), and fracture gradient, among others. Additional features also may be related to one or more combinations of the above example features. As an example, a feature may include a combination of a high slurry rate and a low number of perforations.

The prediction model engine 204 may use the data features to predict subsurface metrics and the predicted subsurface metrics may be compared with actual subsurface metrics based on downhole sensor data.

The error model engine 206 can be used to generate one or more error models or auxiliary models that can be used to indicate an estimated prediction error for the one or more hydraulic fracturing wells based on the difference between the predicted subsurface metrics and actual subsurface metrics. The predicted subsurface metrics may be provided by the prediction model engine 204. The estimated prediction error can be used to indicate that additional data associated with the one or more features may be used to improve the prediction model. However, it is important to determine which of the one or more features may be most related to the error.

The error model engine 206 can indicate a status associated with each of the one or more data features associated with the prediction model. As an example, the status may be one of low, good, minor, or minimal (green), mediocre or medium (yellow), or high or poor (red). In addition, the error model engine 206 may also indicate a status associated with one or more model characteristics used to generate the prediction model and/or the error model. The error model engine 206 can be used to determine which of the data features is most likely to have caused the error in the prediction error. This may indicate that additional data is to be obtained and analyzed for data features having a status above a particular threshold. As an example, if a data feature has a high or red status, this may indicate that additional data should be collected. As another example, if a data feature has a yellow or medium status, this may indicate that additional data should be collected. Alternatively, it may be determined whether the status associated with each of the one or more features is greater than a particular threshold. If the status is greater than the particular threshold, additional data may be collected for the one or more features.

The hydraulic fracturing subsurface optimization system 201 may be used to collect additional downhole sensor data at a different set of one or more hydraulic fracturing wells to improve the at least one feature associated with the estimated prediction error between the prediction for the subsurface value for the different set of one or more hydraulic fracturing wells and the actual subsurface value.

In a further example, the prediction model engine 204 may generate the one or more prediction models or base models that can be used to predict or determine subsurface metrics for one or more hydraulic fracturing wells. In addition, the prediction model engine 204 may generate a confidence/prediction interval for each of the subsurface metrics that can be used to determine an “error” associated with the predictions. Thus, in this further example, the prediction model engine 204 may incorporate the features of the error model engine 206.

The storage 208 can be any storage device(s) for storing data. In some examples, the storage 208 can include a buffer or cache for storing data for processing by the compute components 202. Moreover, the storage 208 can store data from any of the components of the hydraulic fracturing subsurface optimization system 201. For example, the storage 208 can store input data used by the hydraulic fracturing subsurface optimization system 201, outputs or results generated by the hydraulic fracturing subsurface optimization system 201 (for example, data and/or calculations from the prediction model engine 204, the error model engine 206, etc.), user preferences, parameters and configurations, data logs, documents, software, media items, GUI content, and/or any other data and content.

While the hydraulic fracturing subsurface optimization system 201 is shown in FIG. 2 to include certain components, one of ordinary skill in the art will appreciate that the hydraulic fracturing subsurface optimization system 201 can include more or fewer components than those shown in FIG. 2. For example, the hydraulic fracturing subsurface optimization system 201 can also include one or more memory components (for example, one or more RAMs, ROMs, caches, buffers, and/or the like), one or more input components, one or more output components, one or more processing devices, and/or one or more hardware components that are not shown in FIG. 2.

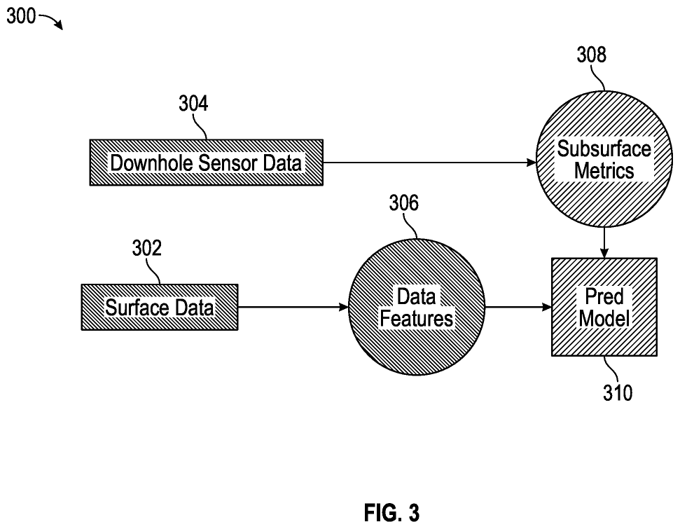

FIG. 3 illustrates a flow diagram 300 for the hydraulic fracturing subsurface sensor optimization system 201 according to an example. The flow diagram 300 of FIG. 3 shows that a prediction model 310 may be generated using data features 306 associated with one or more hydraulic fracturing wells. The prediction model 310 can be used to predict subsurface metrics 308 that may be best determined by downhole sensor data 304. The prediction model 310 can be built based on the one or more data features associated with the one or more hydraulic fracturing wells and the subsurface metrics that can be best determined by the downhole sensor data 304. In short, the prediction model 310 can be used to predict certain subsurface metrics when the one or more features are present. As an example, data has indicated that a subsurface metric X can be determined when feature A=1, B=2, and C=3. As a result, if A=1, B=2, and C=3, the prediction model 310 may predict that subsurface metric is X.

In a first step of the process, a base machine learning model 310 may be built that can be used to predict one or more subsurface metrics 308 that may be normally best determined, calculated, and measured using downhole sensor data 304. The base machine learning model is known as a prediction model 310. The prediction model 310 may be based on machine learning, physics, and/or a combination of machine learning and physics.

In one example, a machine learning model building process may have a collection step including collecting downhole sensor data 304 and surface sensor data 302 from a same set of jobs. In one example, data may be associated with a hundred stages associated with one or more hydraulic fracturing wells. In one example, the hundred stages may be associated with approximately five to ten wells. The one hundred stages may be associated with two or three different formations. The downhole sensor data 304 may be sufficient to define certain subsurface metrics with engineering accuracy. Certain data features 306 may be extracted from the surface data 302. The data features 306 may include the features discussed above and may be associated with location information, reservoir information, completion parameter information, stimulation parameter information, and time-series information, among other information. The machine learning prediction model 310 may be built by configuring characteristics such that it determines a correlation between subsurface data-derived metrics and metrics that are predicted from the surface-derived features. The process of building the model may be iterative. Different data features and model formats may be attempted and used until a best model is determined. The machine learning prediction model 310 may use a variety of different algorithms including one or more of linear regression, lasso, ridge regression, support vector machine, random forest, gradient boosting, and/or deep learning. Deep learning examples include Convolutional neural network (CNN), Long Short-term Memory (LSTM), Gated Recurrent Units (GRU), Autoencoder, and Recurrent neural network (RNN).

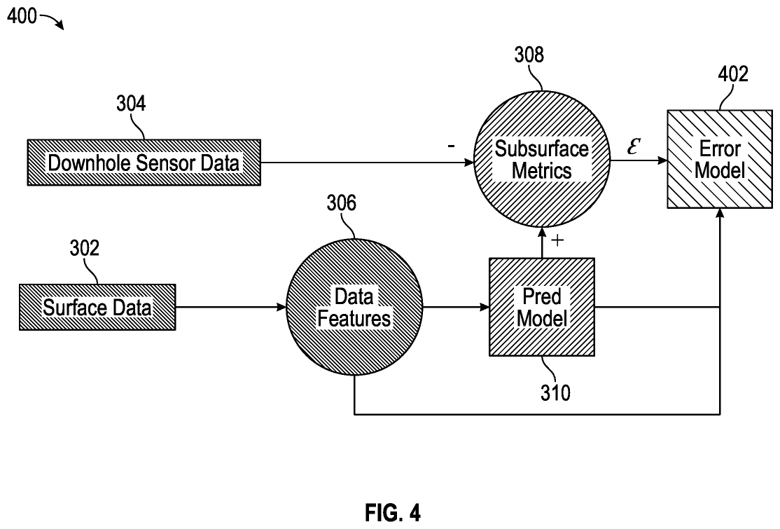

FIG. 4 illustrates another flow diagram 400 for the hydraulic fracturing subsurface sensor optimization system 201 according to an example. After the base machine learning model 310 is built, an auxiliary error model 402 may be built that may be used to predict an error between a prediction of subsurface metrics of the base model or prediction model 310 and actual metrics. As shown in FIG. 4, the error may be built using additional data not used during the original build of the prediction model. The additional data may be determined based on additional test runs after the original set of tests. In addition, the additional data may be a subset of the original data that was intentionally set aside during the building of the prediction model.

As an example, as noted above, the data may be associated with a hundred stages associated with one or more hydraulic fracturing wells. In one example, the hundred stages may be associated with approximately five to ten wells. The one hundred stages may be associated with two or three different formations. Data associated with eighty of the stages (e.g., a first subset of the data) may be used to build the base model or the prediction model. Data associated with the other twenty of the stages (e.g., a second subset of the data) may be used to build the error model.

Once the error model is built, the error model 402 may be used on future jobs where no downhole sensor data 304 is present or there is limited downhole sensor data. The prediction model 310 may be used to predict subsurface metrics 308 based on features extracted from available surface data. At a same time, the prediction based on the prediction model 310 and certain model characteristics such as generated data features may be fed into the error or auxiliary model 402. The error model 402 may provide an estimated prediction error. The estimated prediction error may be a likely difference between an estimation of downhole metrics provided by the prediction model 310 and what would have actually been measured by advanced/downhole sensors. In addition, the error model 402 may be used to determine an estimate of a “status” of key components of features that may contribute to the performance of the prediction model, such as extracted data features and characteristics of the model. As an example, if the original prediction model 310 is built using linear regression, the error model 402 may be used to provide an indication of how specific coefficients are performing when making one or more predictions.

As another example, if the prediction model 310 is a deep neural network, the error model 402 may be used to assess a performance of each layer of the neural network. As a result, the error model 402 may be used to determine if more data and data points may be used to improve the prediction model 310 and how to obtain the data (e.g., associated formation conditions, completion design conditions, and others). This may be used to improve predictive capabilities of the prediction model 310 in a new parameter space. The original parameter space of the prediction model 310 is known. When the prediction model 310 is to be used with different parameters (e.g., a pump rate not tested by the prediction model), a downhole sensor may be used to measure subsurface metrics and an error of the prediction model may be determined. Additionally, a status of one or more key components or features may be determined using the error model 402. Once an error and status of key components or features is known, a new test space and an applicability of the prediction model 310 may be determined.

The error model 402 may be used to determine an estimated error of the prediction model 310. In addition, the error model 402 may be used to understand additional data and measurements to reduce the error. Domain space and designs for unconventional reservoirs may change at a rapid pace. Thus, each prediction model 310 may have to be verified regularly.

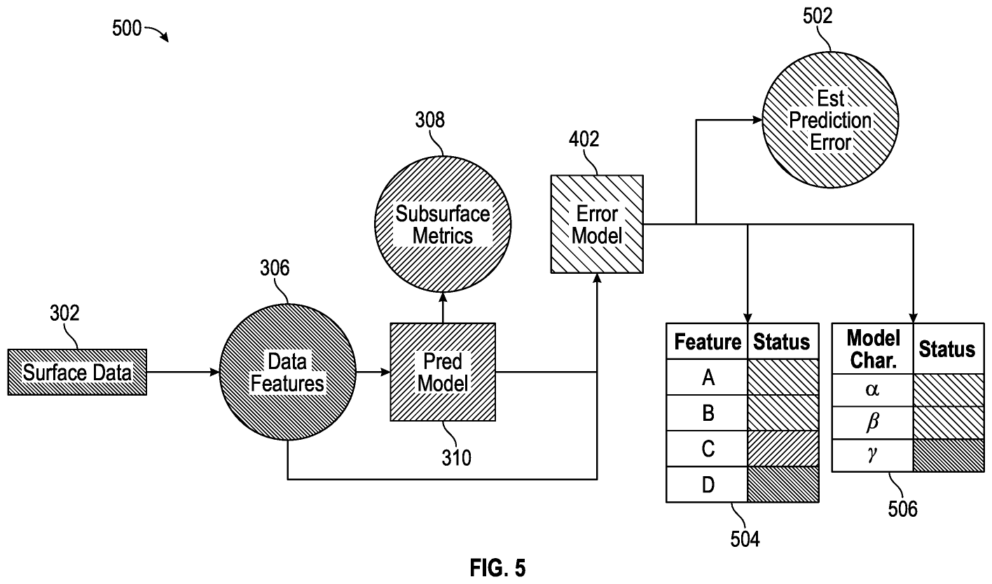

FIG. 5 illustrates another flow diagram 500 for the hydraulic fracturing subsurface sensor optimization system 201 according to an example. As shown in FIG. 5, surface data 302 is used to determine data features 306 associated with one or more hydraulic fracturing wells. The data features may be provided to the prediction model 310 to determine predictions of subsurface metrics 308. The prediction provided by the prediction model also may be provided to the error model 402. The error model provides an estimated prediction error 502 and indicates one or more features 504 and one or more model characteristics 506. The error model 402 may provide a status for each of the one or more features and for each of the model characteristics. As an example, feature A and feature B have a good status. Feature C may have a poor status. Feature D may have a mediocre status. Model characteristic alpha and model characteristic beta may have a good status. However, model characteristic gamma may have a mediocre status.

As a result, the next time there is an opportunity to obtain data from downhole sensors, the hydraulic fracturing subsurface optimization system 201 may focus on obtaining data associated with feature C. Feature D is less important, but additional data may be obtained. In addition, model characteristic gamma may be modified. After additional data is collected for feature C, the hydraulic fracturing subsurface sensor optimization system 201 may again determine the prediction provided by the prediction model. The prediction provided by the prediction model also may be provided to the error model 402. The error model provides an estimated prediction error and indicates one or more features 504 and one or more model characteristics 506. The error model 402 may provide a status for each of the one or more features and for each of the model characteristics. As an example, feature A and feature B have a good status. Feature C may have a good status. Feature D may now have a poor status. At this point, the next time there is an opportunity to obtain data from downhole sensors, the hydraulic fracturing subsurface optimization system 201 may focus on obtaining data associated with feature D.

Additionally, the models may be supplemented to accept measurements from downhole sensors and/or downhole sensor-derived subsurface metrics. Instead of providing predictions of subsurface metrics, the hydraulic fracturing subsurface sensor optimization system 201 may be used to provide control actions to improve the metrics (e.g., changing rate, introducing diverter or other chemicals, and others). The control model may be used in place of the prediction model 310 and the error model 402 may be used to determine when certain control actions are no longer effective. The control actions may not be effective due to a change in the environment or use of the control model with fracturing operations in a new environment. The error model 402 may be used to provide information to plan additional tests such as including new and expanded control actions to update the control model. This may be used to quickly improve the effectiveness of decisions in the new operational environment.

As another example, the subsurface metrics 308 that may be defined by downhole sensor data may be replaced with a well-productivity metric such as twelve-month cumulative production. The error model 402 may be used to predict an inaccurate prediction of production resulting from a hydraulic fracturing operation. This may be used to improve the production metric. Further tests may be planned to improve the prediction model in the future.

The prediction model 310 and the error model 402 may be used on a current job to determine the performance and accuracy of the prediction model 310. In addition, the prediction model 310 and the error model 402 may be used to provide an estimate of errors before the new job begins. As an example, the prediction model 310 may be used in a new location or area that is different from a previous location or area. In other example, the prediction model 310 may be used with a new completion design that is different from a previous completion design. Estimates of the surface data or surface data-derived features may be obtained for the new operational space. The data could be obtained before using the prediction model 310 to determine if downhole sensor measurements should be obtained and downhole sensors deployed on the job before it begins.

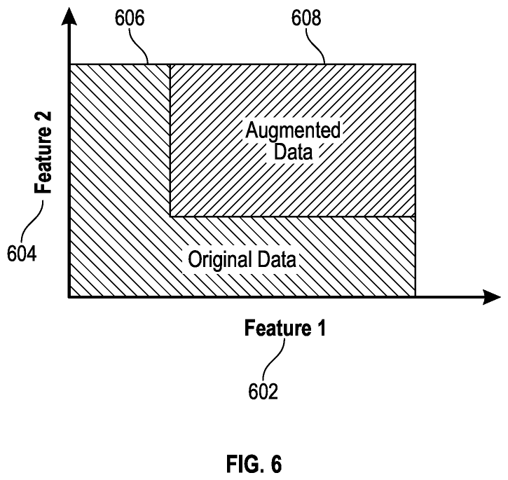

FIG. 6 is a diagram of data and augmented data associated with the hydraulic fracturing subsurface sensor optimization system 201, according to an example. As shown in FIG. 6, original data 606 associated with the prediction model associated with a first feature 602 and a second feature 604 may be further improved by adding augmented data 608. In other words, synthetic data may be generated using interpolation and/or extrapolation of the existing feature space to increase a size and robustness of the dataset.

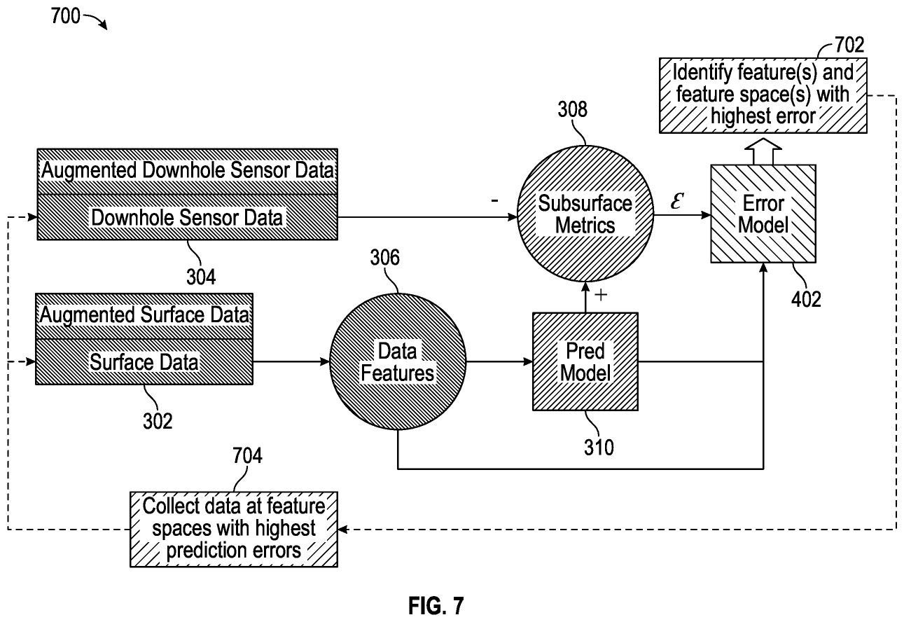

FIG. 7 is a flow diagram 700 of the hydraulic fracturing subsurface optimization system 201 showing collection of data for features having highest prediction errors, according to an example. This may include augmenting the existing surface data 302 and subsurface data 304 using techniques such as SMOTE (Synthetic Minority Over-Sampling Technique) and/or DARE (Data Augmented Regression for Extrapolation). Next, the prediction machine learning model 310 may be built for the complete dataset including the augmented data and the original surface data to predict subsurface metrics 308. Next, the error model 402 may be built that captures the error between the prediction as determined prediction model and subsurface metrics 308.

In 702, feature spaces in the current data and augmented data may be identified to determine where errors and discrepancies may be highest. In 704, this allows the hydraulic fracturing subsurface optimization system 201 to collect actual subsurface data associated with one or more feature spaces to improve the prediction model that utilizes only the surface data.

FIG. 8 illustrates an example method 800 for hydraulic fracturing subsurface sensor optimization. For the sake of clarity, the method 800 is described in terms of the hydraulic fracturing subsurface optimization system 201, as shown in FIG. 2, configured to practice the method. The steps outlined herein are exemplary and can be implemented in any combination thereof, including combinations that exclude, add, or modify certain steps.

At step 802, the hydraulic fracturing subsurface optimization system 201 can receive surface data associated with at least one first hydraulic fracturing well. In addition, the hydraulic fracturing subsurface optimization system 201 can receive downhole sensor data associated with the at least one first hydraulic fracturing well. The hydraulic fracturing subsurface optimization system 201 can store the surface data and the downhole sensor data in storage 208. The hydraulic fracturing subsurface system 201 can augment the downhole sensor data with synthetic downhole sensor data and augment the surface data with synthetic surface data.

At step 804, the hydraulic fracturing subsurface optimization system 201 can generate a prediction model for the at least one first hydraulic fracturing well that can determine a prediction for a subsurface value for the at least one first hydraulic fracturing well. The subsurface value may be one of a number of subsurface metrics. The prediction model may be a machine learning model.

At step 806, the hydraulic fracturing subsurface optimization system 201 can generate an error model for the at least one first hydraulic fracturing well that determines an estimated prediction error between the prediction for the subsurface value for the at least one first hydraulic fracturing well and an actual subsurface value for the at least one first hydraulic fracturing well. The estimated prediction error may be based on downhole sensor data for the at least one first hydraulic fracturing well. As a result, the error model can indicate one or more features that were most responsible for contributing to increase error.

At step 808, the hydraulic fracturing subsurface optimization system 201 can determine a status of at least one feature associated with the estimated prediction error between a prediction for a subsurface value for at least one second hydraulic fracturing well and an actual subsurface value for the at least one second hydraulic fracturing well. The at least one second hydraulic fracturing well is different from the at least one first hydraulic fracturing well used to develop the prediction model and the error model. The at least one feature may be based on one or more of location information, reservoir information, completion parameter information, stimulation parameter information, and time-series information. The location information may be related to at least one of a latitude/longitude, true vertical depth (TVD), measured depth (MD), and well trajectory. The reservoir information may be related to at least one of porosity, permeability, and total organic carbon content. The completion parameter information may be related to at least one of lateral length, stage spacing, well spacing, cluster spacing, a number of clusters, a number of perforations, and a number of stages. The stimulation parameter information may be related to at least one of a total proppant amount, a total fluid amount, and a chemical amount. The time-series information may be related to at least one of a slurry rate, a proppant concentration, a treating pressure, and a chemical concentration.

At step 810, the hydraulic fracturing subsurface optimization system 201 can collect additional downhole sensor data at the at least one second hydraulic fracturing well to improve the at least one feature associated with the estimated prediction error between the prediction for the subsurface value for the at least one second hydraulic fracturing well and the actual subsurface value.

Having disclosed example systems, methods, and technologies for activating or triggering one or more downhole tools or memory devices based at least in part on one or more surface cues and sensed downhole activities, the disclosure now turns to FIG. 9, which illustrates an example computing device architecture 900 which can be employed to perform various steps, methods, and techniques disclosed herein. The various implementations will be apparent to those of ordinary skill in the art when practicing the present technology. Persons of ordinary skill in the art will also readily appreciate that other system implementations or examples are possible.

FIG. 9 illustrates an example computing device architecture 900 of a computing device which can implement the various technologies and techniques described herein. For example, the computing device architecture 900 can implement the system 201 shown in FIG. 2 and perform various steps, methods, and techniques disclosed herein. The components of the computing device architecture 900 are shown in electrical communication with each other using a connection 905, such as a bus. The example computing device architecture 900 includes a processing unit (CPU or processor) 910 and a computing device connection 905 that couples various computing device components including the computing device memory 915, such as read only memory (ROM) 920 and random access memory (RAM) 925, to the processor 910.

The computing device architecture 900 can include a cache of high-speed memory connected directly with, in close proximity to, or integrated as part of the processor 910. The computing device architecture 900 can copy data from the memory 915 and/or the storage device 930 to the cache 912 for quick access by the processor 910. In this way, the cache can provide a performance boost that avoids processor 910 delays while waiting for data. These and other modules can control or be configured to control the processor 910 to perform various actions. Other computing device memory 915 may be available for use as well. The memory 915 can include multiple different types of memory with different performance characteristics. The processor 910 can include any general purpose processor and a hardware or software service, such as service 1 932, service 2 934, and service 3 936 stored in storage device 930, configured to control the processor 910 as well as a special-purpose processor where software instructions are incorporated into the processor design. The processor 910 may be a self-contained system, containing multiple cores or processors, a bus, memory controller, cache, etc. A multi-core processor may be symmetric or asymmetric.

To enable user interaction with the computing device architecture 900, an input device 945 can represent any number of input mechanisms, such as a microphone for speech, a touch-sensitive screen for gesture or graphical input, keyboard, mouse, motion input, speech and so forth. An output device 935 can also be one or more of a number of output mechanisms known to those of skill in the art, such as a display, projector, television, speaker device, etc. In some instances, multimodal computing devices can enable a user to provide multiple types of input to communicate with the computing device architecture 900. The communications interface 940 can generally govern and manage the user input and computing device output. There is no restriction on operating on any particular hardware arrangement and therefore the basic features here may easily be substituted for improved hardware or firmware arrangements as they are developed.

Storage device 930 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 925, read only memory (ROM) 920, and hybrids thereof. The storage device 930 can include services 932, 934, 936 for controlling the processor 910. Other hardware or software modules are contemplated. The storage device 930 can be connected to the computing device connection 905. In one aspect, a hardware module that performs a particular function can include the software component stored in a computer-readable medium in connection with the necessary hardware components, such as the processor 910, connection 905, output device 935, and so forth, to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (for example, microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool. Additionally, the illustrate embodiments are illustrated such that the orientation is such that the right-hand side is downhole compared to the left-hand side.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Moreover, claim language reciting “at least one of” a set indicates that one member of the set or multiple members of the set satisfy the claim. For example, claim language reciting “at least one of A and B” means A, B, or A and B.

Statements of the disclosure include:

Statement 1: A method comprising receiving, by at least one processor, surface data associated with at least one first hydraulic fracturing well, receiving, by the at least one processor, downhole sensor data associated with the at least one first hydraulic fracturing well, generating, by the at least one processor, a prediction model for the at least one first hydraulic fracturing well that determines a prediction for a subsurface value for the at least one first hydraulic fracturing well, generating, by the at least one processor, an error model for the at least one first hydraulic fracturing well that determines an estimated prediction error between the prediction for the subsurface value for the at least one first hydraulic fracturing well and an actual subsurface value for the at least one first hydraulic fracturing well, determining, by the at least one processor, a status of at least one feature associated with the estimated prediction error between a prediction for a subsurface value for at least one second hydraulic fracturing well and an actual subsurface value for the at least one second hydraulic fracturing well, and collecting, by the at least one processor, additional downhole sensor data at the at least one second hydraulic fracturing well to improve the at least one feature associated with the estimated prediction error between the prediction for the subsurface value for the at least one second hydraulic fracturing well and the actual subsurface value.

Statement 2: A method according to Statement 1, further comprising augmenting the downhole sensor data with synthetic downhole sensor data and augmenting the surface data with synthetic surface data.

Statement 3: A method according to any of Statements 1 and 2, wherein the at least one feature is based on location information, reservoir information, completion parameter information, stimulation parameter information, and time-series information.

Statement 4: A method according to any of Statements 1 through 3, wherein the location information comprises at least one of a latitude/longitude, true vertical depth (TVD), measured depth (MD), and well trajectory.

Statement 5: A method according to any of Statements 1 through 4, the reservoir information comprises at least one of porosity, permeability, and total organic carbon content.

Statement 6: A method according to any of Statements 1 through 5, wherein the completion parameter information comprises at least one of lateral length, stage spacing, well spacing, cluster spacing, a number of clusters, a number of perforations, and a number of stages.

Statement 7: A method according to any of Statements 1 through 6, wherein the stimulation parameter information comprises at least one of a total proppant amount, a total fluid amount, and a chemical amount.

Statement 8: A method according to any of Statements 1 through 7, wherein the time-series information comprises at least one of a slurry rate, a proppant concentration, a treating pressure, and a chemical concentration.

Statement 9: A method according to any of Statements 1 through 8, wherein the prediction model comprises a machine learning model.

Statement 10: A system comprising, at least one processor coupled with at least one computer-readable storage medium having stored therein instructions which, when executed by the at least one processor, causes the system to: receive surface data associated with at least one first hydraulic fracturing well, receive downhole sensor data associated with the at least one first hydraulic fracturing well, generate a prediction model for the at least one first hydraulic fracturing well that determines a prediction for a subsurface value for the at least one first hydraulic fracturing well, generate an error model for the at least one first hydraulic fracturing well that determines an estimated prediction error between the prediction for the subsurface value for the at least one first hydraulic fracturing well and an actual subsurface value for the at least one first hydraulic fracturing well, determine a status of at least one feature associated with the estimated prediction error between a prediction for a subsurface value for at least one second hydraulic fracturing well and an actual subsurface value for the at least one second hydraulic fracturing well, and collect additional downhole sensor data at the at least one second hydraulic fracturing well to improve the at least one feature associated with the estimated prediction error between the prediction for the subsurface value for the at least one second hydraulic fracturing well and the actual subsurface value.

Statement 11: A system according to Statement 10, the at least one processor further to execute instructions to augment the downhole sensor data with synthetic downhole sensor data and augment the surface data with synthetic surface data.

Statement 12: A system according to any of Statements 10 and 11, wherein the at least one feature is based on location information, reservoir information, completion parameter information, stimulation parameter information, and time-series information.

Statement 13: A system according to any of Statements 10 through 12, wherein the location information comprises at least one of a latitude/longitude, true vertical depth (TVD), measured depth (MD), and well trajectory.

Statement 14: A system according to any of Statements 10 through 13, wherein the reservoir information comprises at least one of porosity, permeability, and total organic carbon content.

Statement 15: A system according to any of Statements 10 through 14, wherein the completion parameter information comprises at least one of lateral length, stage spacing, well spacing, cluster spacing, a number of clusters, a number of perforations, and a number of stages.

Statement 16: A system according to any of Statements 10 through 15, wherein the stimulation parameter information comprises at least one of a total proppant amount, a total fluid amount, and a chemical amount.

Statement 17: A system according to any of Statements 10 through 16, wherein the time-series information comprises at least one of a slurry rate, a proppant concentration, a treating pressure, and a chemical concentration.

Statement 18: A system according to any of Statements 10 through 17, wherein the prediction model comprises a machine learning model.

Statement 19: A non-transitory computer-readable storage medium comprising instructions stored on the non-transitory computer-readable storage medium, the instructions, when executed by one more processors, cause the one or more processors to perform operations including: receiving surface data associated with at least one first hydraulic fracturing well, receiving downhole sensor data associated with the at least one first hydraulic fracturing well, generating a prediction model for the at least one first hydraulic fracturing well that determines a prediction for a subsurface value for the at least one first hydraulic fracturing well, generating an error model for the at least one first hydraulic fracturing well that determines an estimated prediction error between the prediction for the subsurface value for the at least one first hydraulic fracturing well and an actual subsurface value for the at least one first hydraulic fracturing well, determining a status of at least one feature associated with the estimated prediction error between a prediction for a subsurface value for the at least one second hydraulic fracturing well and an actual subsurface value for the at least one second hydraulic fracturing well, and collecting additional downhole sensor data at the at least one second hydraulic fracturing well to improve the at least one feature associated with the estimated prediction error between the prediction for the subsurface value for the at least one second hydraulic fracturing well and the actual subsurface value.

Statement 20: A non-transitory computer-readable storage medium according to Statement 19, the operations further comprising augmenting the downhole sensor data with synthetic downhole sensor data and augmenting the surface data with synthetic surface data.

Statement 21: A system comprising means for performing a method according to any of Statements 1 through 9.

We claim:

1. A method comprising:
receiving, by at least one processor, surface data associated with at least one first hydraulic fracturing well;
receiving, by the at least one processor, downhole sensor data associated with the at least one first hydraulic fracturing well;
generating, by the at least one processor, a prediction model for the at least one first hydraulic fracturing well that determines a prediction for a subsurface value for the at least one first particular hydraulic fracturing well;
generating, by the at least one processor, an error model for the at least one first hydraulic fracturing well that determines an estimated prediction error between the prediction for the subsurface value for the at least one first hydraulic fracturing well and an actual subsurface value for the at least one first hydraulic fracturing well;
determining, by the at least one processor, a status of at least one feature associated with the estimated prediction error between a prediction for a subsurface value for at least one second hydraulic fracturing well and an actual subsurface value for the at least one second hydraulic fracturing well; and
collecting, by the at least one processor, additional downhole sensor data at the at least one second hydraulic fracturing well to improve the at least one feature associated with the estimated prediction error between the prediction for the subsurface value for the at least one second hydraulic fracturing well and the actual subsurface value.

2. The method of claim 1, further comprising augmenting the downhole sensor data with synthetic downhole sensor data and augmenting the surface data with synthetic surface data.

3. The method of claim 1, wherein the at least one feature is based on location information, reservoir information, completion parameter information, stimulation parameter information, and time-series information.

4. The method of claim 3, wherein the location information comprises at least one of a latitude/longitude, true vertical depth (TVD), measured depth (MD), and well trajectory.

5. The method of claim 3, wherein the reservoir information comprises at least one of porosity, permeability, and total organic carbon content.

6. The method of claim 3, wherein the completion parameter information comprises at least one of lateral length, stage spacing, well spacing, cluster spacing, a number of clusters, a number of perforations, and a number of stages.

7. The method of claim 3, wherein the stimulation parameter information comprises at least one of a total proppant amount, a total fluid amount, and a chemical amount.

8. The method of claim 3, wherein the time-series information comprises at least one of a slurry rate, a proppant concentration, a treating pressure, and a chemical concentration.

9. The method of claim 1, wherein the prediction model comprises a machine learning model.

10. A system comprising:
at least one processor coupled with at least one computer-readable storage medium having stored therein instructions which, when executed by the at least one processor, causes the system to:
receive surface data associated with at least one first hydraulic fracturing well;
receive downhole sensor data associated with the at least one first hydraulic fracturing well;
generate a prediction model for the at least one first hydraulic fracturing well that determines a prediction for a subsurface value for the at least one first hydraulic fracturing well;
generate an error model for the at least one first hydraulic fracturing well that determines an estimated prediction error between the prediction for the subsurface value for the at least one first hydraulic fracturing well and an actual subsurface value for the at least one first hydraulic fracturing well;
determine a status of at least one feature associated with the estimated prediction error between a prediction for a subsurface value for at least one second hydraulic fracturing well and an actual subsurface value for the at least one second hydraulic fracturing well; and
collect additional downhole sensor data at the at least one second hydraulic fracturing well to improve the at least one feature associated with the estimated prediction error between the prediction for the subsurface value for the at least one second hydraulic fracturing well and the actual subsurface value.

11. The system of claim 10, the at least one processor further to execute instructions to augment the downhole sensor data with synthetic downhole sensor data and augment the surface data with synthetic surface data.

12. The system of claim 10, wherein the at least one feature is based on location information, reservoir information, completion parameter information, stimulation parameter information, and time-series information

13. The system of claim 12, wherein the location information comprises at least one of a latitude/longitude, true vertical depth (TVD), measured depth (MD), and well trajectory.

14. The system of claim 12, wherein the reservoir information comprises at least one of porosity, permeability, and total organic carbon content.

15. The system of claim 12, wherein the completion parameter information comprises at least one of lateral length, stage spacing, well spacing, cluster spacing, a number of clusters, a number of perforations, and a number of stages.

16. The system of claim 12, wherein the stimulation parameter information comprises at least one of a total proppant amount, a total fluid amount, and a chemical amount.

17. The system of claim 12, wherein the time-series information comprises at least one of a slurry rate, a proppant concentration, a treating pressure, and a chemical concentration.

18. The system of claim 10, wherein the prediction model comprises a machine learning model.

19. A non-transitory computer-readable medium having instructions stored thereon that, when executed by at least one processor, cause the at least one processor to perform operations comprising:
receiving surface data associated with at least one first hydraulic fracturing well;
receiving downhole sensor data associated with the at least one first hydraulic fracturing well;
generating a prediction model for the at least one first hydraulic fracturing well that determines a prediction for a subsurface value for the at least one first hydraulic fracturing well;
generating an error model for the at least one first hydraulic fracturing well that determines an estimated prediction error between the prediction for the subsurface value for the at least one first hydraulic fracturing well and an actual subsurface value for the at least one first hydraulic fracturing well;
determining a status of at least one feature associated with the estimated prediction error between a prediction for a subsurface value for at least one second hydraulic fracturing well and an actual subsurface value for the at least one second hydraulic fracturing well; and
collecting additional downhole sensor data at the at least one second hydraulic fracturing well to improve the at least one feature associated with the estimated prediction error between the prediction for the subsurface value for the at least one second hydraulic fracturing well and the actual subsurface value.

20. The non-transitory computer-readable medium of claim 19, the operations further comprising augmenting the downhole sensor data with synthetic downhole sensor data and augmenting the surface data with synthetic surface data.
